(19) United States
(12) Patent Application Publication
(10) Pub. No.: US 2015/0309309 A1
(43) Pub. Date: Oct. 29, 2015

(54) DISPLAY DEVICE COMPRISING A DISPLAY SCREEN WITH CONTROLLED TRANSPARENCY

(71) Applicant: THALES, Neuilly Sur Seine (FR)

(72) Inventors: Laurent LALUQUE, Bordeaux (FR); Sebastien ELLERO, Francescas (FR); Johanna DOMINICI, Eysines (FR); Philippe AUGEREAU, Cestas (FR)

(21) Appl. No.: 14/648,598

(22) PCT Filed: Nov. 28, 2013
(86) PCT No.: PCT/EP2013/074965

§ 371 Date: May 29, 2015

(30) Foreign Application Priority Data
Nov. 30, 2012 (FR) 1203246

(51) Int. Cl. G02B 27/01; G02F 1/1334

(52) U.S. Cl. CPC G02B 27/0101; G02F 1/1334

(57) ABSTRACT

The general field of the invention is that of display devices comprising at least one image projector comprising an image generator, projecting optics and a display screen, the image of said image generator being projected by the projecting optics onto said display screen. The display device according to the invention comprises means allowing the degree of optical transmission and the degree of optical scattering of said display screen to be controlled so as to make it completely transparent or completely scattering, the image being projected only in the latter case.

The field of the invention is that of the display devices found in the cockpits of civil and military aircraft.

At the present time, most of the visible area of the instrument panels of modern aircraft cockpits is taken up by display screens and instruments, thus decreasing direct vision of the outside world in the bottom part of the cockpit. In a certain number of applications, including low-altitude visual flight, this absence of direct vision may be a disadvantage.

A first simple solution consists in the pilot stretching in order to see over the display screens, when this is possible.

A second solution consists in using collimated display systems, also referred to as “see through” systems. These systems may essentially be divided into two large families, i.e. the visor of the helmet worn on the head of the pilot and the display devices referred to as “head-up” displays, which are more permanently installed in the cockpit. These devices superpose information taking the form of imagery or symbology on the outside world.

The latter pieces of equipment have the particularity of being collimated, i.e. the information issued from an image generator is projected to “infinity” by means of suitable optics. The pilot therefore has no need to accommodate on the information or outside world, both being clearly seen simultaneously. These pieces of equipment have a certain technical complexity and are therefore very expensive. In addition, the information is presented in a specific way in order not to mask the background scene, i.e. the representation is different to that of what are referred to as “head-down” displays. It therefore requires some effort on the part of the pilot, when he moves his gaze between the “head-up” and “head-down” displays, to make sense of what he is seeing.

The object of the invention is to provide a display device allowing either a symbology equivalent to that of a head-down display to be displayed on an opaque screen, or a perfectly transparent window to be created onto the outside world (no information then being displayed). Thus, in instrument flight, conventional information as displayed on other head-down screens is displayed, no particular cognitive effort being required to read it. However, if the pilot is in visual flight, he may transform the screen into a transparent window in order to see the outside world without obstruction.

In addition, the proposed screen has a large zone of use or “eye box” that is identical to that of a liquid-crystal display, thereby increasing its comfort of use; in contrast a head-up display has, by nature, a small eye box corresponding to the pupil of the collimating optics used.

More precisely, the subject of the invention is a display device comprising at least one image projector comprising an image generator, projecting optics and a display screen, the image of said image generator being projected by the projecting optics onto said display screen, characterized in that the display device comprises means allowing the degree of optical transmission and the degree of optical scattering of said display screen to be controlled.

Advantageously, the display device comprises means arranged so as to turn off automatically the image generator when the degree of optical transmission is maximal and to turn on automatically the image generator when the degree of optical scattering is maximal.

Advantageously, the display screen comprises a touch surface making it possible to interact with the image projected onto the display screen.

Advantageously, the display device comprises regulating means allowing the position of the projected image to be kept constant on the display screen.

Advantageously, said regulating means comprise accelerometers fastened on the one hand to the image generator or to the projecting optics and on the other hand to the display screen.

Advantageously, said regulating means on the one hand comprise at least one alignment mark integrated into the periphery of the image, at least one optical sensor placed on the periphery of the display screen and means for analyzing images issued from said optical sensor, said means being arranged so as to detect the movement of the image of said mark over said optical sensor.

Advantageously, the display screen is a PDLC screen, the acronym PDLC standing for “polymer-dispersed liquid crystal”, and comprises a layer of liquid crystals mixed in polymers, said layer being encapsulated between two transparent electrodes, the optical transparency and optical scattering of said layer being controlled by a control voltage applied to said electrodes.

The invention will be better understood and other advantages will become apparent on reading the following nonlimiting description, and by virtue of the appended figures in which:

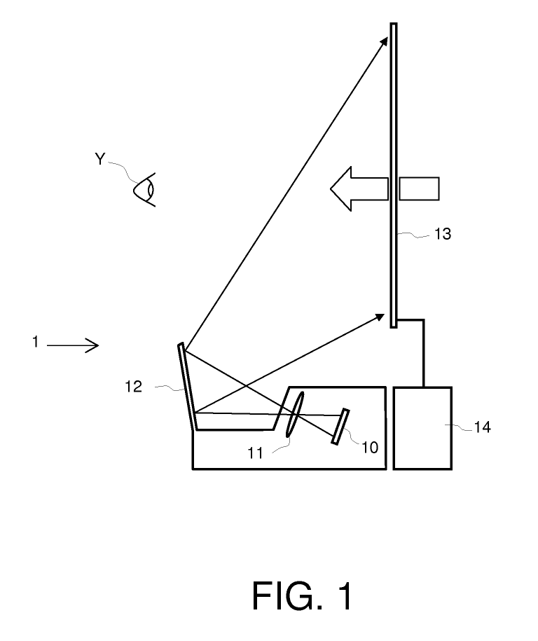

FIG. 1 shows a cross-sectional view of a display device according to the invention;

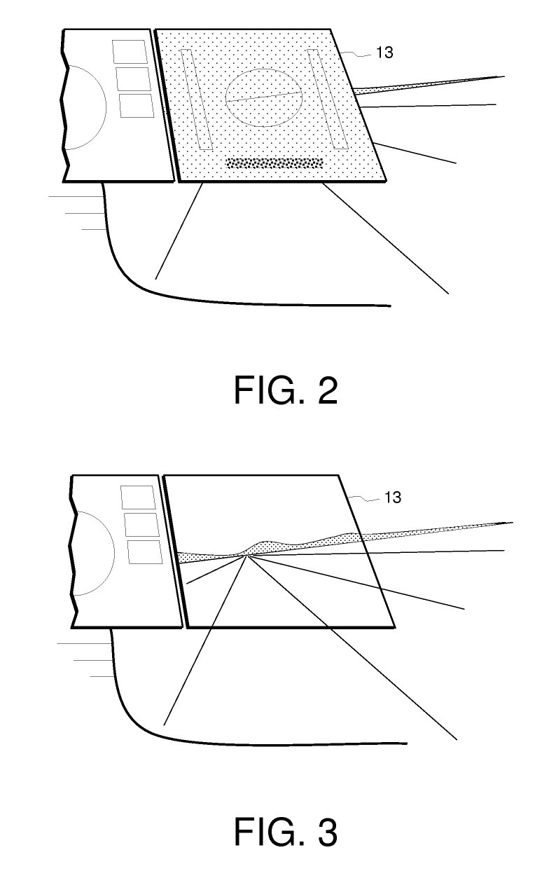

FIG. 2 shows a display screen according to the invention in transmissive mode; and

FIG. 3 shows a display screen according to the invention in display mode.

FIG. 1 shows a cross-sectional view of a display system comprising an image projector according to the invention. This projector 1 essentially comprises an image generator 10, projecting optics 11 and a display screen 13 and means 14 for controlling said display screen.

The image generator 10 may generate monochromatic images or color images. Any type of image generator may be suitable for use in the system according to the invention. Generally, the image generator is small and no bigger than a few centimeters in size. It has a high resolution. It generally comprises a passive matrix modulator and a powerful light source. The modulator may be a matrix of liquid crystals (also known as an LCD) or an electromechanical modulator based on micro-mirrors or MEMS. The light sources may be light-emitting diodes, lasers or arc lamps.

The projecting optics 11 are conventional optics having a high magnification so as to form a greatly enlarged image of the image generator on the front side of the display screen 13. It is possible to redirect the optical beams using mirrors 12, as is shown in FIG. 1, so as to decrease bulk and reduce visual masking of the projection system. In order to guarantee a compact solution is obtained, it is possible to use a compact short throw projector.

The display screen 13 is a PDLC screen, the acronym PDLC standing for “polymer-dispersed liquid crystal”. It comprises a layer of liquid crystals mixed in polymers, said layer being encapsulated between two transparent electrodes; the optical transparency and optical scattering of the layer is controlled by a control voltage applied to said electrodes. This voltage is about a few volts to a few tens of volts depending on the thickness of the layer and the properties of the liquid crystals. It is delivered by the control means 14 depending on commands given by the user.

The PDLC film is encapsulated between two glass sheets that have undergone a treatment allowing its optical performance, and in particular its optical transmission, to be optimized. The side seen by the pilot is given an antireflection treatment in order to limit specular reflection as much as possible. The back side for its part is treated in order to reflect light rays originating from outside the cockpit, which could create parasitic reflections that could possibly decrease the readability of the displayed information.

In the absence of a voltage between the two electrodes, the material is white and scattering. It behaves like an optical scatterer that will scatter the projected image. If a high-enough switching or control voltage is applied, the material becomes transparent.

Thus, by virtue of this technique the display screen behaves like a conventional “head-down” display device in the absence of a control voltage across the PDLC film, as may be seen in FIG. 2 which shows a partial view of an instrument panel. In the presence of the control voltage, it becomes transparent and the pilot may see through to the outside world, as may be seen in FIG. 3.

In order not to disrupt the field of view of the pilot, when the screen becomes transparent, it is preferable for the image source to be inhibited. A plurality of technical solutions are envisageable. By way of a first example solution, on switching of the PDLC film the system turns off the source of backlighting of the imager used. By way of a second example, an electronic shutter blocks the exit pupil of the optical system.

By default, the display system functions in an “all or nothing” mode, i.e. the PDLC screen is either completely transparent or completely opaque. By modulating the control voltage of the film, it is possible to adjust the screen to a semitransparent mode that allows the pilot to see the outside world while the information most relevant to his mission remains visible on the screen.

Optionally, the screen may be made interactive while remaining transparent by adding a touch surface thereto. There are various techniques allowing a touch surface to be produced. The touch surface may be based on the use of optical means. A light reflector is installed all the way around the display screen. An assembly comprising optical emitter/receivers is housed in the system for holding the screen in place. Thus, it is possible to detect interaction of the pilot with the screen. The touch surface may also be a projected capacitive touch surface. A capacitive touch panel is then adhesively bonded to the PDLC film.

The technical field of this type of display device is the field of aircraft instrument panels. In this type of application, the device may be subjected to substantial levels of vibrations or temperature variations. It is therefore important to couple and interlock the assembly comprising the display and the projecting optics with the display screen in order to limit the impact of the environment on the quality and position of the image.

There are various techniques for solving this problem. It is possible to couple the various elements of the display system physically with the constraints that this involves such as the presence of struts in the field of view of the pilot.

They may be coupled virtually by detecting, at each moment in time, the position of the display screen relative to the projection assembly. Various coupling techniques exist. It is possible to place accelerometers on the various elements, these accelerometers allowing the position of the screen and the projected image to be regulated.

It is also possible to project one or more marks integrated into the projected image onto the system for holding the screen in place, which comprises one or more pairs of light-sensitive sensors. Analyzing means allow the position and orientation of the marks to be determined with precision. The latter technique is described in the patent application FR 2 959 023 entitled “Systeme de visualisation multi-projecteurs asservi”. These sensors may in addition serve to regulate the brightness of the projector depending on the exterior or ambient brightness. They may also control other features of the projected image such as its color. Lastly, they may detect screen freeze and thus serve as malfunction indicators.

1. A display device comprising at least one image projector comprising an image generator, projecting optics and a display screen, the image of said image generator being projected by the projecting optics onto said display screen, wherein the display device comprises means allowing the degree of optical transmission and the degree of optical scattering of said display screen to be controlled.

2. The display device as claimed in claim 1, wherein the display device comprises means arranged so as to turn off automatically the image generator when the degree of optical transmission is maximal and to turn on automatically the image generator when the degree of optical scattering is maximal.

3. The display device as claimed in claim 1, wherein the display screen comprises a touch surface making it possible to interact with the image projected onto the display screen.

4. The display device as claimed in claim 1, wherein the display device comprises regulating means allowing the position of the projected image to be kept constant on the display screen.

5. The display device as claimed in claim 4, wherein said regulating means comprise accelerometers fastened on the one hand to the image generator or to the projecting optics and on the other hand to the display screen.

6. The display device as claimed in claim 4, wherein said regulating means on the one hand comprise at least one alignment mark integrated into the periphery of the image, at least one optical sensor placed on the periphery of the display screen and means for analyzing images issued from said optical sensor, said means being arranged to detect the movement of the image of said mark over said optical sensor.

7. The display device as claimed in claim 1, wherein the display screen is a PDLC screen, the acronym PDLC standing for “polymer-dispersed liquid crystal”, and comprises a layer of liquid crystals mixed in polymers, said layer being encapsulated between two transparent electrodes, the optical transparency and optical scattering of said layer being controlled by a control voltage applied to said electrodes.
